(19) United States
(12) Patent Application Publication
(10) Pub. No.: US 2005/0210104 A1
(43) Pub. Date: Sep. 22, 2005

(54) Method and system for presence enhanced group management and communication

(76) Inventor: Marko Torvinen, Espoo (FI)

Correspondence Address: CRAWFORD MAUNU PLLC, 1270 NORTHLAND DRIVE, SUITE 390, ST. PAUL, MN, 55120, US

(21) Appl. No.: 10/804,462

(22) Filed: Mar. 19, 2004

(51) Int. Cl. G06F 15/173; G06F 15/16

(52) U.S. Cl. 709/205; 709/225

(57) ABSTRACT

A system and method uses presence information to enhance group management functions. The presence enhanced group management allows sharing of information between group members, management of availability and contact information associated with the group members, and group/group member availability definitions having a variety of various meanings within the scope of a group definition. The presence enhanced group management functions allow groups and their associated presence information to function as mediators of all types of information between members of the group to include synchronization of calendars and task lists. Group based channels of communication are also facilitated to support message exchange between the group members.

### FIELD OF THE INVENTION

This invention relates in general to presence, and more particularly to presence enhanced group formation and management.

### BACKGROUND OF THE INVENTION

Where mobile telephones were perhaps viewed by many as a luxury when first introduced into the marketplace, they are today viewed by our society as very important, convenient, and useful tools. A great number of people now carry their mobile devices with them wherever they go. This popularity of wireless communication has spawned a multitude of new wireless systems, devices, protocols, etc. Consumer demand for advanced wireless functions and capabilities has also fueled a wide range of technological advances in the utility and capabilities of wireless devices. Wireless/mobile devices not only allow voice communication, but also facilitate other communication paradigms such as messaging, multimedia communications, e-mail, Internet browsing, and access to a wide range of wireless applications and services.

In view of the many communication paradigms in existence today, the emergence of presence technology in the mobile domain has provided the consumer with a technique to better control his or her own availability and communication preference. Presence enables a new communication paradigm of “look before you communicate”, where users are able to determine whether: the other party is available for communication; the other party wishes to communicate; and through what means the other party wishes to be contacted.

Service enablers like presence enhanced communication have contributed to the growth and acceptance of the mobile communications industry. As this growth continues, other service enablers, such as location services and group management, may augment the utility of presence information in various ways. Thus, the mobile communication industry continues to introduce and develop value added services that combine one or a combination of multiple service enablers to further enhance the mobile terminal user's experience. In this way, the present invention continues the trend of enhancing the mobile terminal user's experience through development of service enablers in the area of location services, group management, and presence.

### SUMMARY OF THE INVENTION

To overcome limitations in the prior art, and to overcome other limitations that will become apparent upon reading and understanding the present specification, the present invention discloses a system and method of presence enhanced group management.

In accordance with one embodiment of the invention, a method to enhance group communication within a network using presence information comprises maintaining presence information associated with a group of terminals, maintaining presence information associated with each member of the group of terminals, and activating a group communication channel from a first member of the group of terminals to available terminals within the group of terminals. Availability is determined using presence information associated with the group of terminals and presence information associated with each member of the group of terminals.

In accordance with another embodiment of the invention, a presence enhanced group communication system comprises terminals coupled through a network to form a group and presence servers coupled to the network and adapted to maintain presence information associated with each of the terminals and adapted to maintain presence information associated with the group. The terminals comprise a group presence module adapted to communicate with the presence servers to maintain availability status of the group and each terminal within the group. A group communication channel is established in response to the availability status.

In accordance with another embodiment of the invention, a mobile terminal is wirelessly coupled to a network which includes a group of mobile terminals wirelessly coupled to the network. The mobile terminal comprises a memory capable of storing at least one of a group presence module and a protocol module, a processor coupled to the memory and configured by the group presence module to formulate an availability status associated with each member of the group of mobile terminals, and a transceiver configured to facilitate content exchange with available members of the group. The available members are selected in accordance with their availability status.

In accordance with another embodiment of the invention, a computer-readable medium has instructions stored thereon and are executable by a mobile terminal for establishing a group communication channel with a group of mobile terminals in a network. The instructions perform steps comprising accumulating presence information associated with the group and each member of the group of mobile terminals, determining availability of each member using the accumulated presence information, displaying the availability of each member, and creating the group communication channel in response to programmable rules of availability.

In accordance with another embodiment of the invention, a server is coupled to a network to facilitate presence based group communication. The server comprises a means for accumulating presence information relating to a group, a means for accumulating presence information relating to each member of the group, a means for providing the group presence and member presence information in response to requests received for the presence information, and a means for determining availability status of the group and each member of the group in response to programmable rules of availability received from one of the members of the group.

In accordance with another embodiment of the invention, a computer-readable medium has instructions stored thereon which are executable by a server to facilitate group communication. The instructions perform steps comprising accumulating presence information relating to a group, accumulating presence information relating to each member of the group, providing the group presence and member presence information in response to requests received for the presence information, and determining availability status of the group and each member of the group in response to programmable rules of availability received from one of the members of the group.

In accordance with another embodiment of the invention, a method of managing presence information associated with a group to establish a communication channel with the group comprises activating an information field associated with the group, monitoring presence information associated with the group, determining an availability status of the group based on the presence information, and communicating the information field to the group in response to its availability status.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system and method in accordance with the invention.

### BRIEF DESCRIPTION OF THE DRAWINGS

The invention is described in connection with the embodiments illustrated in the following diagrams.

FIG. 1 illustrates an exemplary communication system that may be used in accordance with the present invention;

FIG. 2 illustrates an exemplary Session Initiation Protocol (SIP) network in accordance with the present invention;

FIG. 3 illustrates an exemplary group based communication channel in accordance with the present invention;

FIG. 4 illustrates an exemplary presentation of group presence in accordance with the present invention;

FIG. 5 illustrates a group level concept of group management in accordance with the present invention;

FIG. 6 illustrates an alternate embodiment of a group based communication channel in accordance with the present invention;

FIG. 7 illustrates an exemplary group synchronization event in accordance with the present invention;

FIG. 8 illustrates a flow diagram of an exemplary method in accordance with the present invention;

FIG. 9 illustrates an alternate flow diagram of an exemplary method in accordance with the present invention;

FIG. 10 illustrates an alternate flow diagram of an exemplary method in accordance with the present invention;

FIG. 11 illustrates a representative mobile computing arrangement suitable for initiating and managing presence enhanced group management functions in accordance with the present invention; and

FIG. 12 is a representative computing system capable of carrying out location/presence server functions according to the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system and method that adds presence enabled features to group management. That is to say, that a particular owner of any mobile group may create a group-specific presence instance of a group, while continuing to use the group, for example, as a buddy list. Thus, the present invention enables utilization of groups as group specific communication channels to which group members may subscribe and utilize. The present invention facilitates communication channels that are used to share information between group members as well as providing a common reference point for the group members to be used to automate presence status changes for the group and its members.

Group presence, in accordance with the present invention, may not only provide a communication channel that is used by the various group members to share information, but may also provide a group's reference point as to group member availability. That is to say, for example, that the calendar or task list of one group member's agenda may be shared with the other members of the group, such that a presence status change for that group member may be automatically updated to the other members of the group. Such an automated status update may provide utility in organizing group events based upon individual member availability.

Many utilization scenarios in which group presence enhances the mobile terminal user's experience are contemplated by the present invention. In one embodiment in accordance with the present invention, a utilization scenario enables information sharing between members of a group through the use of presence as a communication channel between the group's members. In such an instance, for example, sporting clubs like basketball, hockey, or football teams may organize a team practice event or group of events through use of the presence information associated with the team. Where the owner of the group, e.g., the team's coach, wishes to schedule a Saturday team practice, for example, all the team's coach need do is recall the presence information relating to the group, e.g., group membership, current count of group member availability, etc., and submit a single message to the group. Each member of the group then receives the message due to their presence association with that particular group, but also in accordance with their individual presence information.

In other words, while group members, e.g., 1-11, each have a common group association, e.g., recreational football team, they may also have individual presence information that dictates their availability, preferential mode of communication, etc. In such an instance, all group members receive the request for a Saturday practice from the coach, but group members 1-7, for example, receive an Instant Message (IM) indication of the Saturday practice due to their individual “available” status within the group. Group members 8-11, on the other hand, are not currently available and have thus indicated “email” notifications to be used for any group related messages. Thus, through the use of both group and individual presence information in accordance with the present invention, a single message is transmitted by the coach of the football team to each member of the team in accordance with their group presence, but also in accordance with their individual presence as well. It can be seen that virtually any group definition, such as hobby clubs, parties, group competitions, and corporate group activities, etc., may benefit from the use of the present invention.

In another embodiment according to the present invention, a group's presence status may be used as an alternate means to locate availability and contact information concerning the group's members. As such, an additional “quick look” is provided as to the availability of the members of the group, whereby the definition of availability may take on several forms. If availability of each group member is linked to their presence information by their location, for example, then each group member's availability is defined to be their location relative to a specific venue, such as a club house, training facility, or conference room.

Thus, the use of each member's location may augment their current presence information to further define their availability. Taking, for example, a corporate setting where each member of the group is a member of a business team, such presence information may characterize business team members not only as to their location relative to the business office, but also as to their current activity within the office. That is to say, for example, that while some group members may be “in the office” and thus immediately available through voice calls or IM, other group members may be “in the office”, but also “in a meeting” thus precluding immediate contact methods and requiring alternate contact methods such as through the use of email or Short Message Service (SMS) messaging. Still other group members may not be physically located within the office, but nevertheless available for participation in virtual meetings while on travel to another business venue.

Group presence according to the present invention enables groups and their associated presence information to function as intermediaries of information. That is to say that information sharing, presence status, preferred contact types, changes in group members' schedules/data/etc., may be communicated between members of the group. The group may also be free to define its own set of presence attributes, thus allowing management of the group's image as seen by other group members as well as by externalities to the group. Examples of such group presence attributes may include the group's presence status, security level, group icons/logos, application rules for presence, status changes, availability rules for the group, and preferred contact types for the group.

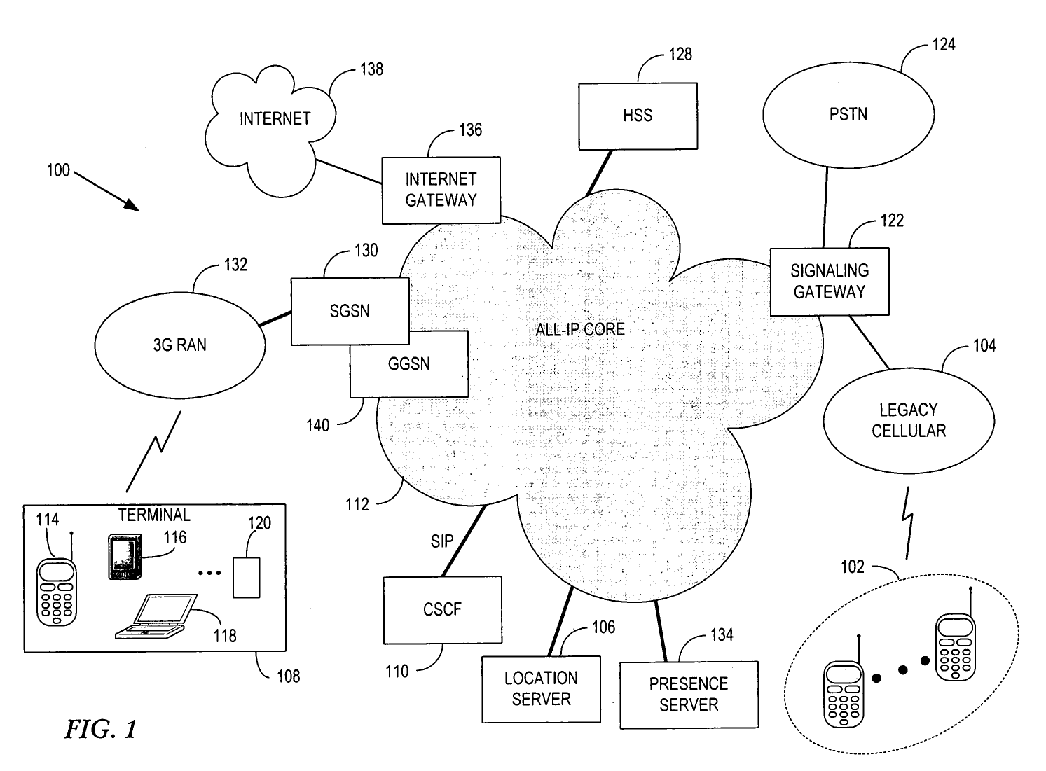

Although several network topologies exist that may support the presence enhanced group management services as described in relation to the present invention. All-Internet Protocol (IP) system 100 of FIG. 1 is described to illustrate one embodiment of a system topology that may be adapted to provide such services. All-IP core 112 provides the common, IP based signaling core that is utilized to integrate various fixed, mobile, and Internet networks. All-IP core 112 allows all communication services to be carried over a single network infrastructure, thus enabling the integration of voice, data, and multimedia services. Further, All-IP core 112 allows network resources to be used more efficiently, where increased capacity may be deployed as necessary to meet demand.

All-IP system 100 is optimized to support multimedia services, where Call State Control Function (CSCF) 110 implementing Session Initiation Protocol (SIP) is a key ingredient in providing such services. Although SIP's primary objective was meant for multimedia sessions, its scope may be extended to presence, gaming, IM, etc., as necessary. Numerous applications can be implemented using SIP, allowing the combination of traditional telephony with messaging and multimedia. Since SIP is text based, it is relatively easy to implement, easy to debug, extensible, and modular.

Wireless terminal 108 may represent any of a number of mobile communication devices, such as a cellular telephone 114, a personal digital assistant (PDA) 116, a notebook or laptop computer 118, or any other type of wireless terminal represented by device 120. 3G Radio Access Network (RAN) 132 represents a combination of all mobile radio standards, such as Global System for Mobile Communications (GSM)/Enhanced Data Rates for Global Evolution (EDGE) and Wideband Code Division Multiple Access (WCDMA), where each mobile radio standard has its own distinct network architectures and transport mechanisms that are fully integrated using the IP protocol. Serving General Packet Radio Service (GPRS) Support Node (SGSN) 130 and Gateway GPRS Support Node 140 provides the RAN interface to All-IP core 112.

All-IP system 100 supports Legacy Cellular systems 104 that offers communication support to non All-IP terminals 102, for example. Signaling gateway 122 performs all necessary Signaling System No. 7 (SS7) and Mobile Application Part (MAP) signaling conversions as necessary to provide SS7 over IP access from PSTN 124 and MAP over IP access from Legacy Cellular system 104 to All-IP core 112. In addition, signaling gateway 122 provides Short Message Service Center (SMSC) support and Multimedia Message Service Center (MMSC) support for any SMS and MMS operations as required by mobile terminals 102.

Internet 138 access from All-IP core 112 is provided through internet gateway 136 to allow access defined by Uniform Resource Locator (URL) and Uniform Resource Identifier (URI) address definitions. Home Subscriber Server (HSS) 128 provides All-IP core 112 with the many database functions that are required in All-IP networks, such as for example, a Home Location Register (HLR) and a Domain Name Server (DNS) (not shown). Location server 106 optionally provides any location based information that may be required in order to link presence data optionally received from presence server 134 concerning mobile terminal groups 108 and/or 102.

Exchange of presence and location information may be facilitated through the use of SIP, since SIP supports: the exchange of content between a set of participants in real time via IM; subscription to and notification of changes in the communication state of a participant via presence; and signalling to any kind of SIP-enabled elements in the network, e.g., HSS 128, location server 106, presence server 134, and any available mobile/land terminals 108 and 102.

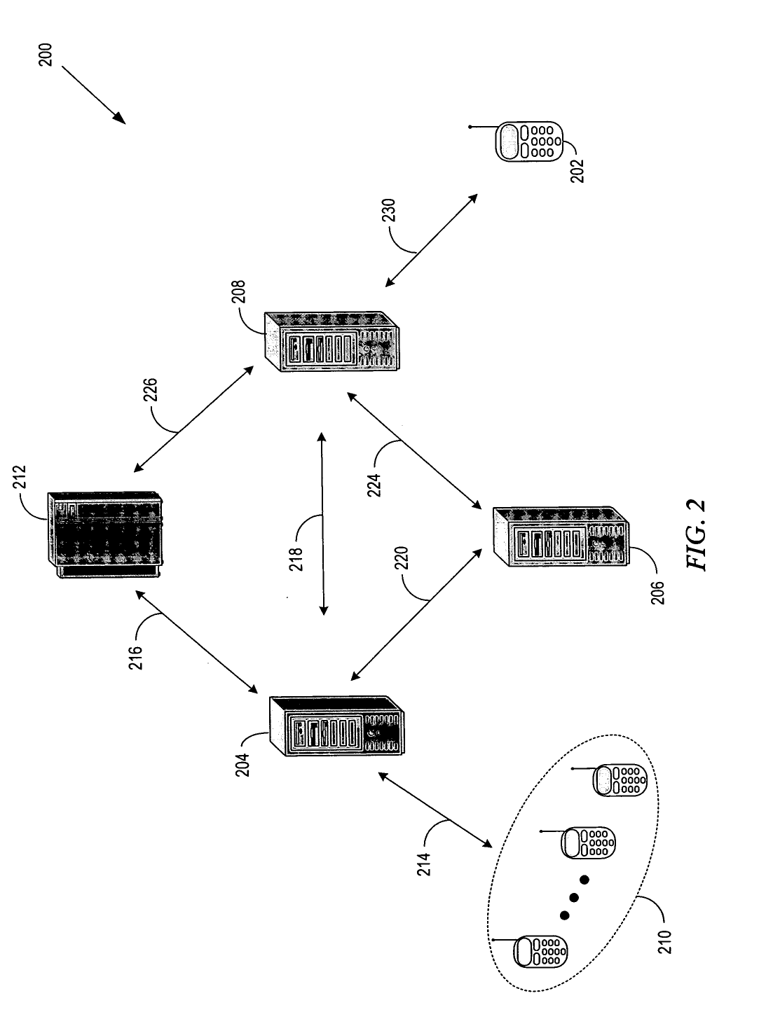

FIG. 2 illustrates exemplary SIP network 200 according to the principles of the present invention, in which location/presence information associated with, for example, group terminals 202, 210 may be provided to SIP servers 204/208 in order to facilitate presence enhanced group management functions. Elements of a SIP enabled network may include user agents, e.g. mobile terminals 202 and 210, SIP servers 204 and 208, location server 206, and presence server 212. User agents are the end devices in a SIP network and they originate SIP requests to establish media sessions to send and receive media. Each user agent comprises a user agent client that initiates requests and a user agent server that generates the responses to the requests.

SIP servers 204 and 208 are servers that assist user agents in session establishment and other functions. SIP servers may represent a SIP proxy that receives SIP requests from a user agent, via paths 214 or 230, or another proxy, via path 218, and forwards the request to another location. SIP servers may also represent a redirect server that receives a request from a user agent or proxy and returns a redirection response indicating where the request should be retried. SIP servers may also represent a registrar server that receives SIP registration requests and updates the user agent's information into a location server, e.g., 206, or other database, via paths 220 or 224. SIP servers 204 and 208 may also access presence information from presence server 212 via paths 216 and 226 associated with either of user agents 202 and/or 210 according to their respective communication states.

Servers 204-208 and 212, for example, may be operated as location/presence components that are used to facilitate group management functions/updates in accordance with the present invention. Location updates, for example, relating to the positions of mobile terminals 202, 210 may be maintained within location server 206, while presence information relating to the communication states of mobile terminals 202, 210 may be maintained within presence server 212. In addition, the presence information relating to group 210 may also be separately maintained within presence server 212 in accordance with the present invention. Presence and location information may be exchanged between SIP servers 204 and 208, such that availability status of mobile terminals 202 and 210 may be determined in response to programmable availability rules. Such availability rules may be predetermined within SIP servers 204 and 208, or may alternately be programmed by mobile terminals 202 and 210 in accordance with group specific rules of availability as discussed in more detail below.

Individual presence information relating to each of mobile terminals 202 and 210 that is maintained within presence server 212, may be subscribed to by any SIP enabled device through the use of the SUBSCRIBE method. Using the SUBSCRIBE method, notification of communication state changes relating to a target terminal may be requested by the subscribing terminal, whereby use of the NOTIFY method is used to report the communication state change to the subscribing terminal once the communication state has changed.

Thus, for example, mobile terminal 202 may issue a SUBSCRIBE request in relation to one of mobile terminals 210 via signalling paths 230 and 226, such that any communication state changes reported by any of mobile terminals 210 via signalling paths 214 and 216 are then relayed back to mobile terminal 202 using the NOTIFY method via paths 226 and 230. In addition, mobile terminal 202 may issue a SUBSCRIBE request in relation to the entire group of mobile terminals 210 via signalling paths 230 and 226, such that any communication state changes relating to the group as reported by any one of mobile terminals 210 via signalling paths 214 and 216 are then relayed back to mobile terminal 202 using the NOTIFY method via paths 226 and 230. It can be seen, therefore, that availability status may alternately be determined by each of mobile terminals 202 and 210 through the use of the various SIP methods to independently manage group and group member communication channels.

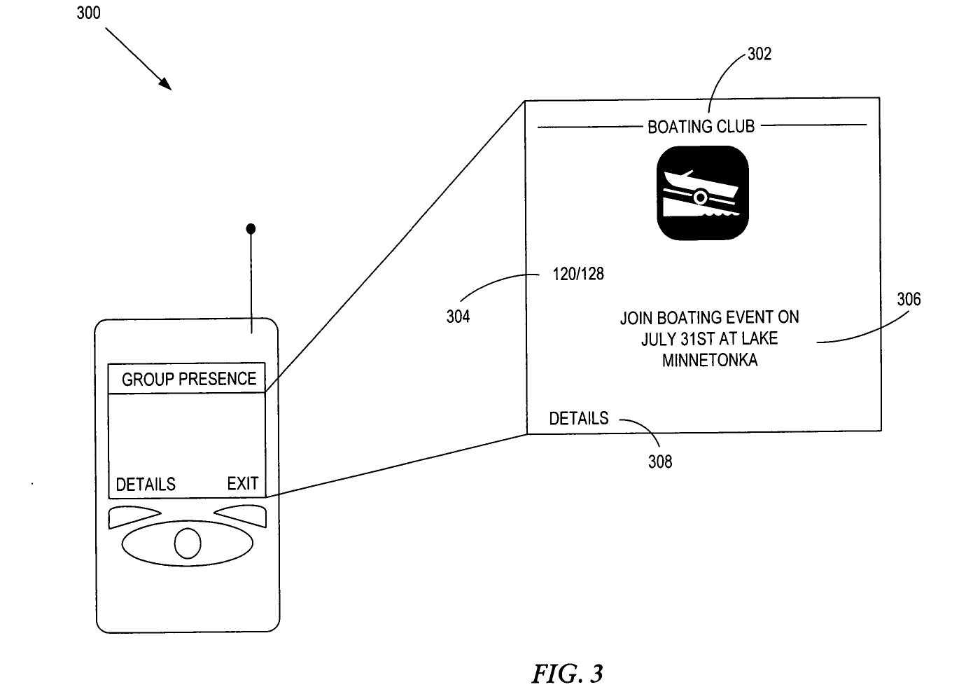

Various scenarios may now be explored to exemplify operation of the present invention. In FIG. 3, for example, a typical communication channel is formed through the use of “BOATING CLUB” 302. “BOATING CLUB” 302 may represent the name of a particular group to which mobile terminals 210 of FIG. 2 belong. In such an instance, for example, mobile terminals 210 belonging to such a group will be automatic recipients of message 306 indicating that a boating event is to take place. The creator of message 306 may be any one of mobile terminals 210 who belong to the “BOATING CLUB” 302 group, or may alternately be an externality having knowledge of the existence of the group.

In one embodiment, the creator of message 306 may be an administrator of Lake Minnetonka, who is trying to organize a boating event and wishes to relay the event's information to as many boating clubs as possible within the area. In such an instance, the administrator has access privileges to presence server 212 to determine the number of boating clubs whose presence information is currently maintained by presence server 212. By subscribing to the presence information of all boating clubs currently registered with presence server 212, the administrator may obtain the number of “available” members 304 within each boating club, along with any detailed communication status 308 associated with each individual member of each boating club, so as to provide delivery of message 306 in accordance with the individual presence information of each boating club member.

In an alternate embodiment, the creator of event 306 may be one of the members of boating club 302, whereby display 300 represents the electronic calendar or task list associated with that particular member. In such an instance, the member may key in event 306 into his July 31st entry of his current year's calendar to remind himself of the boating event to be held at Lake Minnetonka. As an option, the member may then indicate via details 308, that he wishes to synchronize event 306 to the other “available” members 304 of BOATING CLUB 302 after completion of the calendar entry. If such a message upload is desired, message 306 is transferred via paths 214 and 216 to presence server 212 for subsequent dissemination to the remaining “available” members 304 of BOATING CLUB 302.

In an alternate embodiment, the user of mobile terminal 202 of FIG. 2 may be a prospective member of BOATING CLUB 302, in which mobile terminal 202 has subscribed to the group presence of BOATING CLUB 302. In such an instance, once news of the boating event described in message 306 is transmitted either by one of the current members of BOATING CLUB 302 or the administrator of Lake Minnetonka as discussed above, for example, a SIP NOTIFY method is used to provide the presence status change of BOATING CLUB 302 to mobile terminal 202 via paths 226 and 230. The user of mobile terminal 202 is then informed of the upcoming boating event and is free to participate if he so chooses.

It should be noted that group “available” status 304 may have several different meanings in accordance with the present invention. In one embodiment, the denominator, e.g., 128, of “availability” status 304 may indicate that the total membership of BOATING CLUB 302 equals 128 members, whereas the numerator, e.g., 120, of “availability” status 304 may indicate that 120 members of BOATING CLUB 302 will be in driving distance of Lake Minnetonka on July 31st. Thus, a total of 8 members of BOATING CLUB 302 indicate through their individual presence information status, that they will not be within driving distance of Lake Minnetonka on July 31st and do not require receipt of event 306. It is contemplated that the meaning of “availability” status 304 is fully programmable and may indicate any one of a number of various “availability” relationships that may exist among the members of BOATING CLUB 302 as discussed in more detail below.

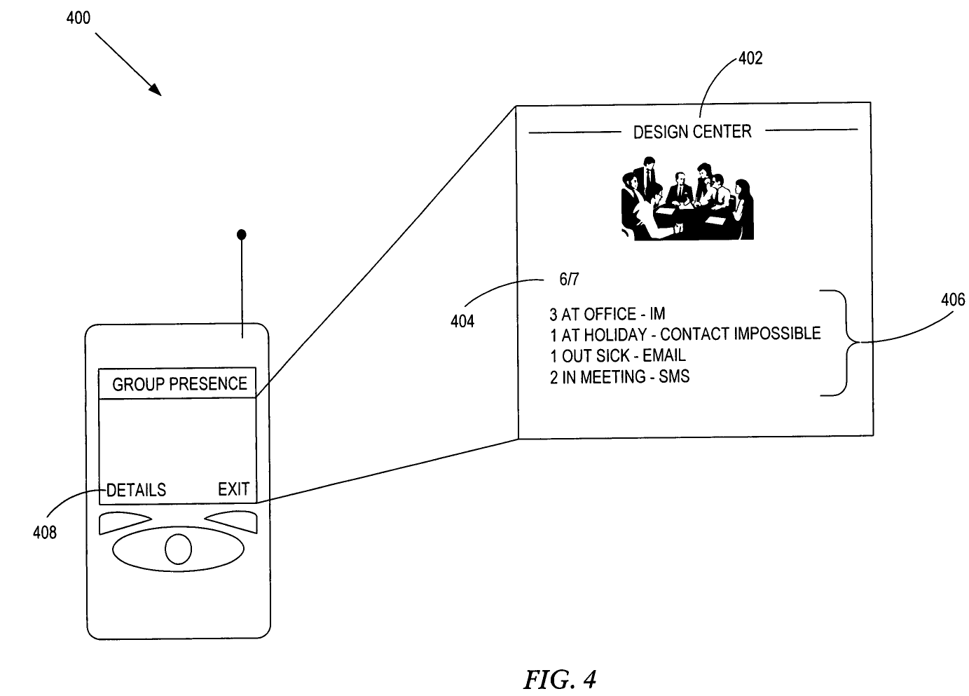

In an alternate expression of group presence in accordance with the present invention, display 400 of FIG. 4 represents the resulting information content received through selection of DETAILS 408 relating to group “DESIGN CENTER” 402. DESIGN CENTER 402 may represent, for example, an engineering group of a telecommunications company, whereby group presence 406 is viewed statistically to gain communication status by grouping of its members. That is to say, that “availability” status 404 indicates, for example, that out of 7 total DESIGN CENTER group members, all but 1 is “available” to some extent. In particular, communication status 406 indicates that: 3 members of the DESIGN CENTER group are in the office and are available via IM communication; 1 member is on holiday and not contactable; 1 is out sick, but available via email; and 2 are in the office and not available due to a meeting, but otherwise contactable via SMS messaging. Thus, FIG. 4 is representative of a two-folded presence information display, whereby group presence is summarized in “availability” status 404 and group presence is individuated through communication status 406.

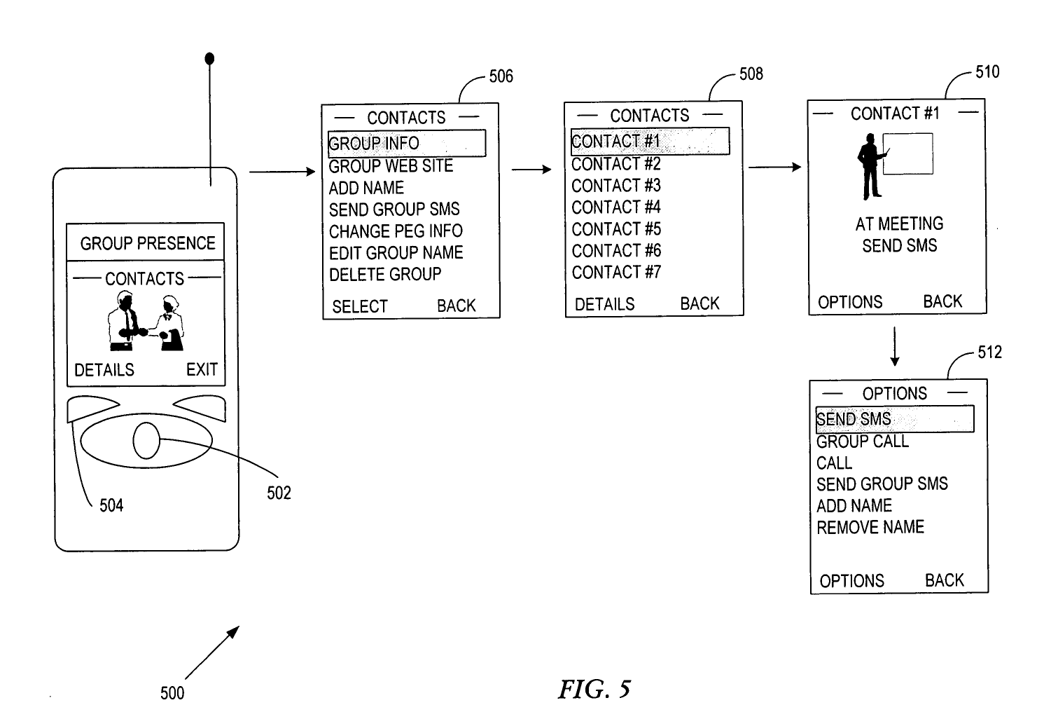

FIG. 5 exemplifies the addition of a group level concept to group management. In particular, mobile terminal 500 may have several groups identified, such as “contacts”, “boating club”, “design center”, “poker club”, etc. Once the “contacts” group has been selected by mobile terminal 500, selection menu 506 is instantiated to allow the user of mobile terminal 500 to conduct operations on the group “contacts”. Several menu items exist for various operations on the “contacts” group as illustrated by selection menu 506. Highlighting the “group info” menu item through depression of select soft key 504 followed by a subsequent depression of select hard key 502 causes individual “contact” list 508 to instantiate, whereby 7 contacts are listed as being members of the “contact” group. Highlighting the “contact #1” menu item through depression of select soft key 504 followed by a subsequent depression of select hard key 502 causes presence information 510 for contact #1 to instantiate, whereby contact #1 is listed as being at a meeting, but otherwise available via SMS messaging. Selection of the “options” sub menu for contact #1 instantiates communications options 512 that are available for contact #1, whereby selection of the “send SMS” menu item allows an SMS message to be sent to contact #1 in accordance with the communication state expressed by contact #1. Thus, it can be seen that presence enhanced group management according to the present invention allows group level management, such that presence information associated with each individual of each group may be located by first selecting the group in which the individual is a member and then choosing from a list of options available for that particular group.

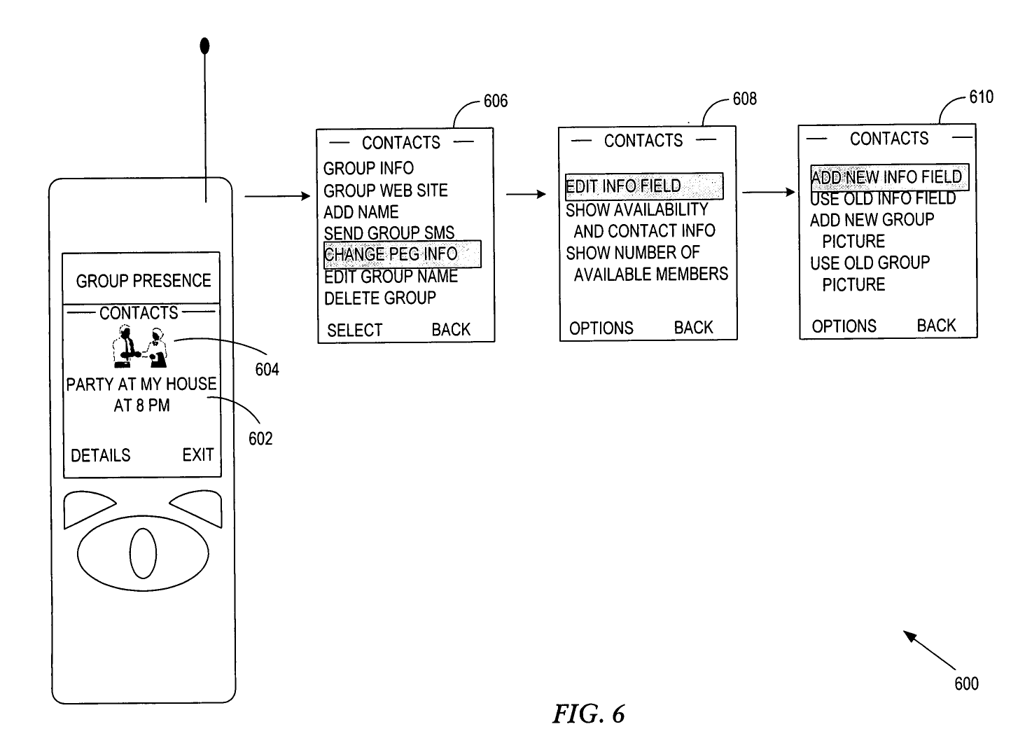

In an alternate embodiment, the present invention is useful in providing group specific communication channels as illustrated by mobile terminal 600 of FIG. 6. In particular, information field 602 indicates that a party is to be held at the home of the user of mobile terminal 600 at 8 pm. Information field 602 may be transmitted automatically to all members of the “contacts” group, simply by associating information field 602 to the “contacts” group prior to sending the message represented by information field 602.

In addition, group management of the “contacts” group in FIG. 6 may take on an alternate meaning as compared to the group management that was discussed in relation to FIG. 5. In particular, the Presence Enhanced Group (PEG) information of menu 606 may be selected in order to edit information field 602, or to display availability and contact information relating to the members of the “contacts” group, or alternately to show the number of “available” members of the “contacts” group. Thus, if the user of mobile terminal 600, for example, wishes to change the time of the party, he may select “edit info field” from menu 608 in order to “add new info field” as offered by menu 610. In such an instance, for example, information field 602 may then be edited to read “party at my house at 7 pm” if an earlier party time is desired. Once edited, the user of mobile terminal 600 may transmit message 602 to all individuals that are identified as being members of the “contacts” group. Alternatively, the user of mobile terminal 600 is given the opportunity to associate a new group icon that is to be displayed by mobile terminal 600 when the “contacts” group is displayed through use of the “add new group picture” selection of menu 610. In such an instance, icon 604 may be replaced by an icon of the user's choice to represent the “contacts” group.

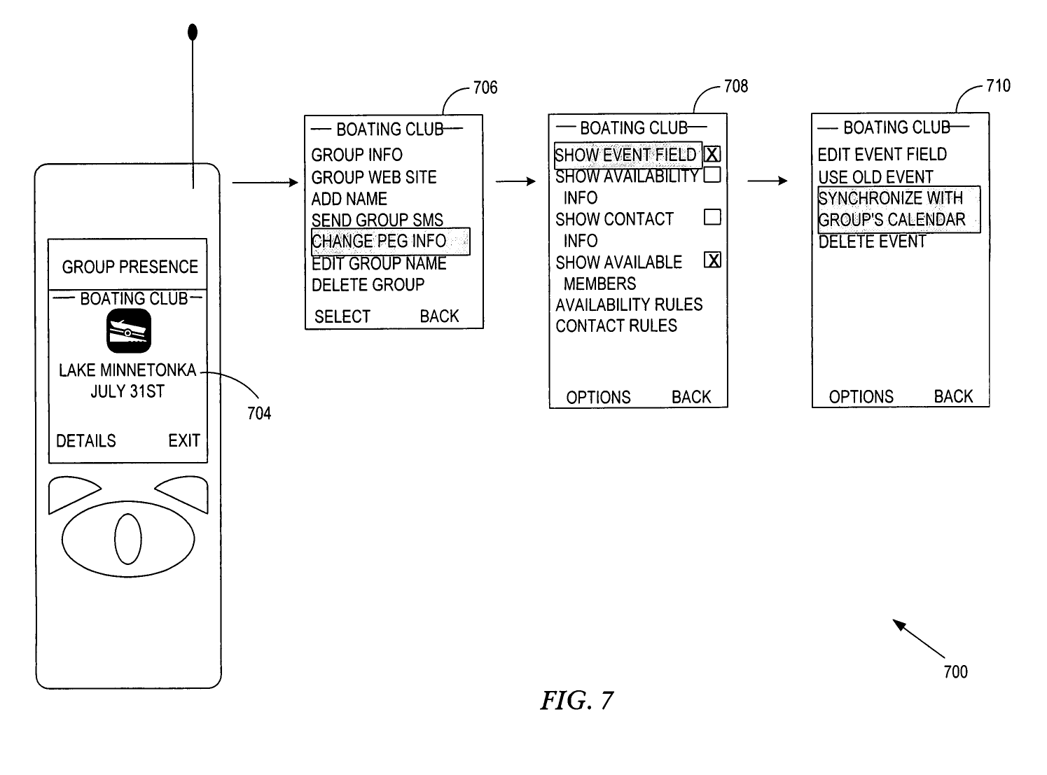

FIG. 7 illustrates an exemplary embodiment whereby synchronization of one member's calendar with the group's calendar is allowed in accordance with the present invention. The user of mobile terminal 700 first selects his electronic calendar, whereby a boating event is listed to take place on Lake Minnetonka on July 31st. From within the electronic calendar menu, the user of mobile terminal 700 selects group presence menu 706. Selection of “change PEG info” from menu 706 instantiates alternate menu 708, whereby the “look and feel” of the PEG options may be edited. Selection boxes of menu 708, for example, indicate that the “show event field” and “show available members” menu selections have been activated by their associated check boxes. Hence, event field 704 is displayed in conjunction with the boating club group's calendar event on July 31st, and any “available” members for that event would be displayed by selection of the DETAILS option.

Further, the “availability rules” selection of menu 708 allows the user to program the meaning of “availability”, whereby “availability” may take on any number of definitions to include location based and activity based “availability” of the group/individual. Still further, highlighting the “show event field” of menu 708 instantiates menu 710, which allows operations to be taken on event field 704. Event field 704 may, for example, be changed, deleted, or synchronized with the “available” BOATING CLUB group members.

If the user wishes to synchronize his July 31st calendar entry with the other “available” members of the BOATING CLUB, then selection of the “synchronize with group's calendar” automatically provides a calendar update to those members. Any available communication means may be invoked to accomplish the synchronization, such as the use of the MESSAGE method to transmit an IM to the receiving members. Receipt of the synchronization message may then be accomplished in background mode, whereby the recipient's calendar is automatically updated with event field 704. Alternately, receipt of the synchronization message may optionally require a verification by the recipient as to whether he wishes to update his calendar with the received synchronization information, or simply make note of the event and discard the synchronization information with no calendar update.

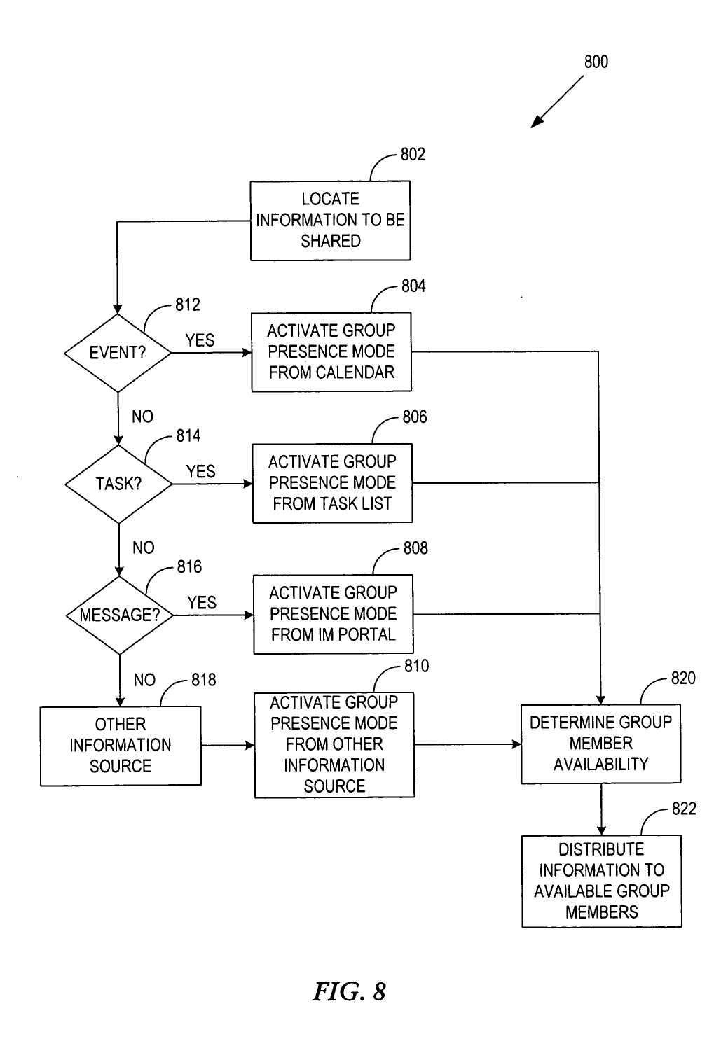

It can be seen that group presence may be utilized in a variety of advantageous methods in accordance with the present invention. For example, the flow diagram of FIG. 8 illustrates exemplary method 800 whereby group presence is utilized as a communication channel between a group's members. In step 802, information to be shared with the group is located. If the information to be shared is an event as in step 812, then group presence mode is activated, for example, from the user's calendar as in step 804. If, on the other hand, the information to be shared is a task as in step 814, then group presence mode is activated, for example, from the user's task list as in step 806. If, on the other hand, the information to be shared is a message as in step 816, then group presence mode is activated, for example, from the user's IM portal as in step 808. If the information to be shared is from some other source as in step 818, then group presence mode is activated from that other source as in step 810. In any event, the “availability” of the individual group members is ascertained as in step 820 and subsequently distributed to those members of the group that are found to be “available” as in step 822. Thus, an association between the presence of the group and the presence of the individual group members is maintained to facilitate presence enhanced group communication channels.

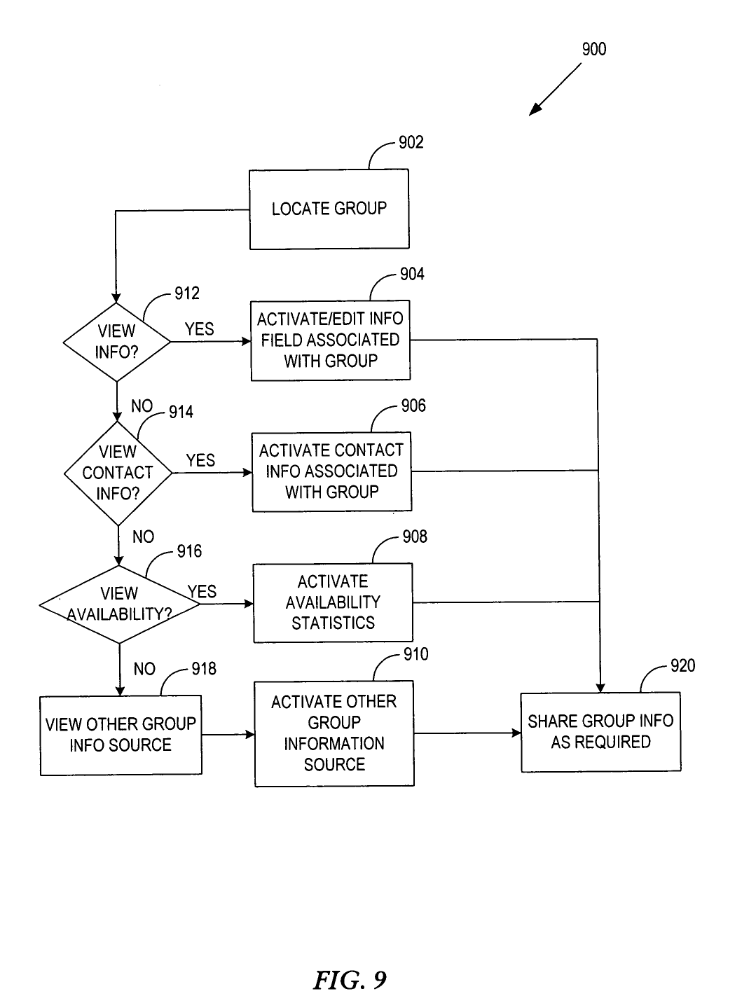

Additionally, the present invention is useful in determining the availability and contact information associated with the members of a group. The exemplary method of FIG. 9 is particularly useful in corporate use when, for example, a team member wishes to learn the availability and communication status of the other team members prior to sharing team information with them. Flow diagram 900 of FIG. 9 exemplifies such a utility whereby the specific group is selected as in step 902. The information field associated with the group is optionally displayed and edited as in steps 912 and 904. Additionally, any contact information may be optionally viewed as in step 914 and 906 to learn how to best contact each member based upon their individual presence. The “availability” of each team member may be gathered and displayed in, for example, statistical format, as determined in steps 916 and 908, such that each group member may be identified as to their desired communication state, e.g., via IM, voice call, email, SMS, etc. Summary information about the “availability” of the group may also be displayed as a ratio of “availability” status to total group membership. Any other group information may be optionally gathered and displayed as in steps 918 and 910, whereby the group information may include group presence information like “under maintenance” to indicate that group software is being upgraded and is not currently available. The group information is then shared as required as in step 920, such that each group member may be kept aware of the group's status and group member status. Optionally, the group's status and group member status may be shared with various interested and authenticated externalities to the group.

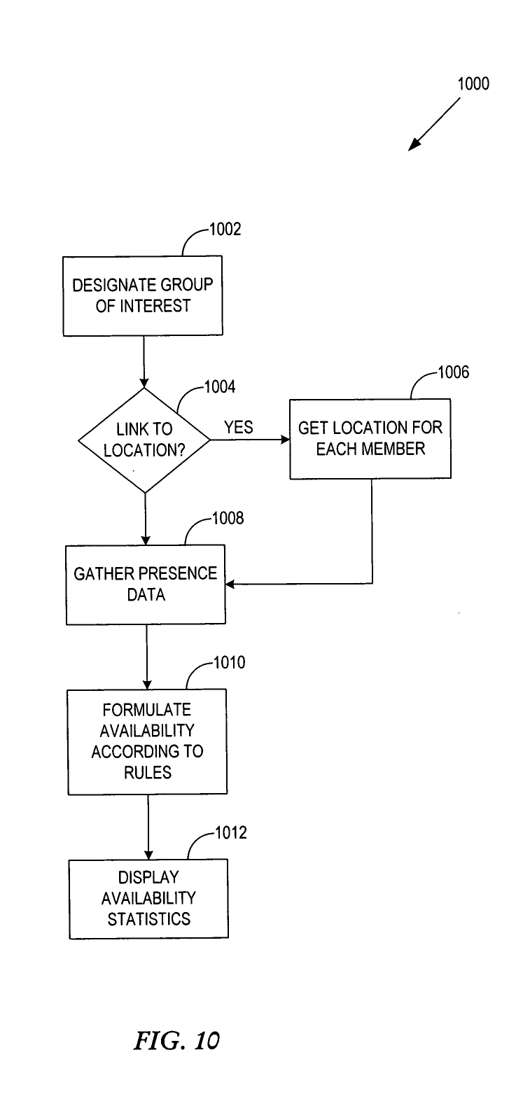

Additionally, the present invention allows a great deal of programmability as to the meaning of group and group member “availability” as exemplified by flow diagram 1000 of FIG. 10. In step 1002, the particular group of interest is identified. If presence is to be associated with the location of each group member as in step 1004, then the location of each member is determined as in step 1006 through, for example, location queries to the members' location servers. Other presence information associated with each group member is gathered in step 1008, which may include location specific activities that the user may be involved in. For example in corporate use, the location of a particular group member may be determined to be “in the office”, but other activity information may further define that user's “availability”, such as: “in the office”, but “having a meeting”; or “in the office”, but “on the phone”; or “out of the office”, but otherwise “available for virtual meeting via video conference”.

Thus it can be seen that based on the availability rules, location information, and activity data, a multitude of “availability” definitions may be determined as in step 1010. For example, the “availability” of each group member to physically attend a meeting in the office is determined to be equal to the number of members of the corporate group that are “in the office” and not otherwise tied up. Another definition of “availability” may be defined as all members who are accessible via email, but are otherwise unavailable due to travel commitments, sick leave, etc. Still other definitions of “availability” involve activity and location combinations that are to take place at some point in the future. That is to say that the “availability” of BOATING CLUB members to attend a boating event on Lake Minnetonka may be predetermined by each member based upon his electronic calendar entries, task list entries, or other source of information that affects “availability.” Once the appropriate “availability” formulations have been made, the appropriate availability statistics may then be displayed as in step 1012 to all interested members of the group or authorized externalities.

The present invention also contemplates the ability for each group to define its own attributes and thus manage its own image as seen by other members of the group and authorized externalities. A group's attributes may include a definition of its current presence status, e.g., “under maintenance” or “available to authorized users only”. A group's attributes may also include, for example, a definition of its own logo or icon. Application rules for presence status changes may also be applied to the group presence definition, such that only those group members having administrator privilege may apply presence changes. Availability rules may also be applied to a group, whereby for example, 100% individual member availability is required for a group to be considered “available.” Preferred contact types for a group may also be specified, e.g., by email if group is un-available, or by IM if group is available, to further define the group's presence properties.

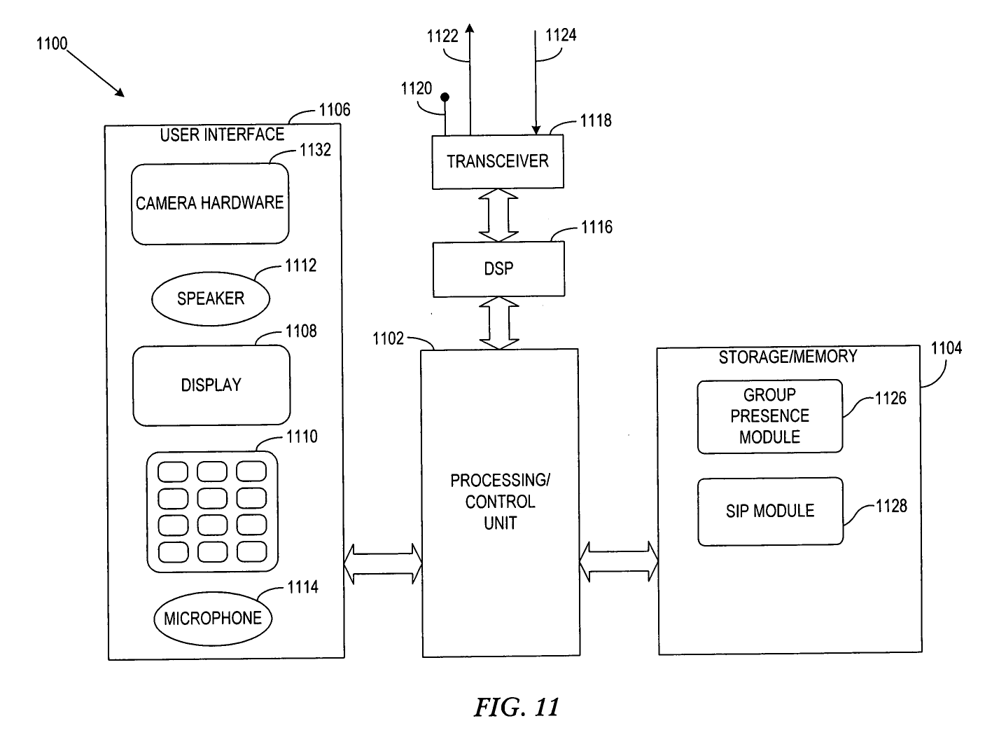

The invention is a modular invention, whereby processing functions within either a mobile terminal or a hardware platform may be utilized to implement the present invention. The mobile terminals may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various presence enhanced group management functions described herein. An example of a representative mobile terminal computing system capable of carrying out operations in accordance with the invention is illustrated in FIG. 11. Those skilled in the art will appreciate that the exemplary mobile computing environment 1100 is merely representative of general functions that may be associated with such mobile devices, and also that landline computing systems similarly include computing circuitry to perform such operations.

The exemplary mobile computing arrangement 1100 suitable for presence enhanced group management functions in accordance with the present invention may be associated with a number of different types of wireless devices. The representative mobile computing arrangement 1100 includes a processing/control unit 1102, such as a microprocessor, reduced instruction set computer (RISC), or other central processing module. The processing unit 1102 need not be a single device, and may include one or more processors. For example, the processing unit may include a master processor and associated slave processors coupled to communicate with the master processor.

The processing unit 1102 controls the basic functions of the mobile terminal, and also those functions associated with the present invention as dictated by group presence module 1126 and SIP module 1128 available in the program storage/memory 1104. Thus, the processing unit 1102 is capable of defining and managing presence enhanced group management functions associated with the present invention, and is further able to communicate via SIP as necessary in performing such functions via SIP module 1128. The program storage/memory 1104 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 1104 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 1100 via data signals, such as being downloaded electronically via one or more networks, such as the Internet and an intermediate wireless network(s).

The processor 1102 is also coupled to user-interface 1106 elements associated with the mobile terminal. The user-interface 1106 of the mobile terminal may include, for example, a display 1108 such as a liquid crystal display, a keypad 1110, speaker 1112, camera hardware 1132, and microphone 1114. These and other user-interface components are coupled to the processor 1102 as is known in the art. Other user-interface mechanisms may be employed, such as voice commands, switches, touch pad/screen, graphical user interface using a pointing device, trackball, joystick, or any other user interface mechanism.

The mobile computing arrangement 1100 also includes conventional circuitry for performing wireless transmissions. A digital signal processor (DSP) 1116 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 1118, generally coupled to an antenna 1120, transmits the outgoing radio signals 1122 and receives the incoming radio signals 1124 associated with the wireless device.

The mobile computing arrangement 1100 of FIG. 11 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a presence enhanced group management system and method in accordance with the present invention.

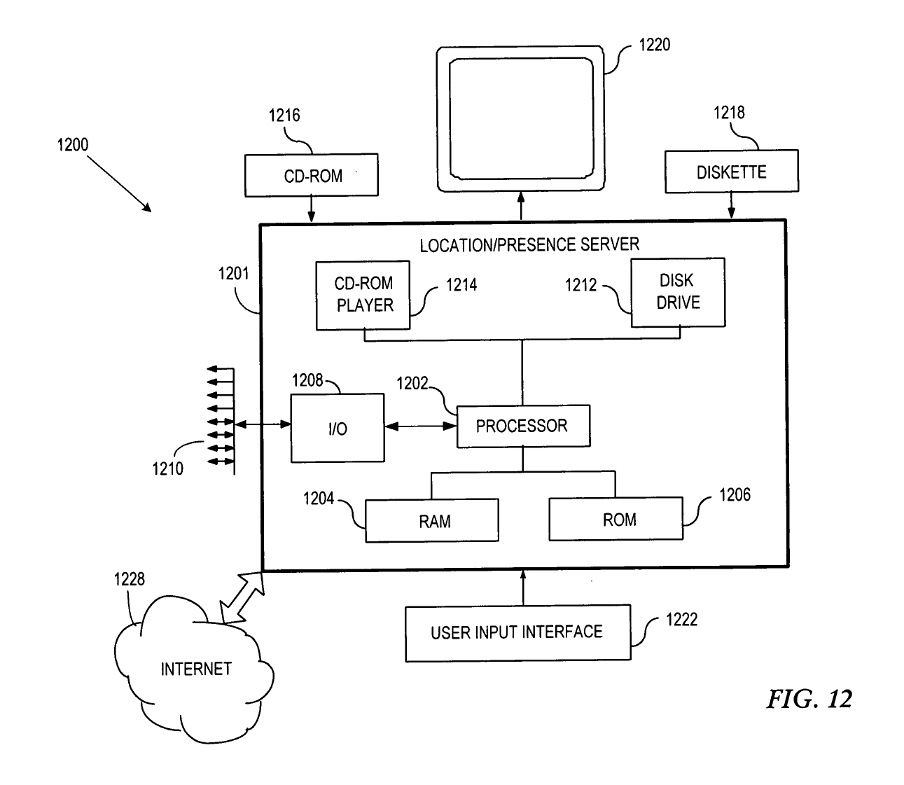

The presence and/or location servers or other systems for providing server functions in connection with the present invention may be any type of computing device capable of processing and communicating digital information. The server platforms utilize computing systems to control and manage the presence enhanced group activity. An example of a representative computing system capable of carrying out operations in accordance with the invention is illustrated in FIG. 12. Hardware, firmware, software or a combination thereof may be used to perform the various presence enhanced group management functions and operations described herein. The computing structure 1200 of FIG. 12 is an example computing structure that can be used in connection with such a location/presence server platform.

The example computing arrangement 1200 suitable for performing the location/presence server activity in accordance with the present invention includes location/presence server 1201, which includes a central processor (CPU) 1202 coupled to random access memory (RAM) 1204 and read-only memory (ROM) 1206. The ROM 1206 may also be other types of storage media to store programs, such as programmable ROM (PROM), erasable PROM (EPROM), etc. The processor 1202 may communicate with other internal and external components through input/output (I/O) circuitry 1208 and bussing 1210, to provide control signals and the like. For example, data received from I/O connections 1208 or Internet connection 1228 may be processed in accordance with the present invention. External data storage devices may be coupled to I/O circuitry 1208 to facilitate location/presence server functions according to the present invention. Alternatively, such databases may be locally stored in the storage/memory of location/presence server 1201, or otherwise accessible via a local network or networks having a more extensive reach such as the Internet 1228. The processor 1202 carries out a variety of functions as is known in the art, as dictated by software and/or firmware instructions.

Location/presence server 1201 may also include one or more data storage devices, including hard and floppy disk drives 1212, CD-ROM drives 1214, and other hardware capable of reading and/or storing information such as DVD, etc. In one embodiment, software for carrying out the presence enhanced group management operations in accordance with the present invention may be stored and distributed on a CD-ROM 1216, diskette 1218 or other form of media capable of portably storing information. These storage media may be inserted into, and read by, devices such as the CD-ROM drive 1214, the disk drive 1212, etc. The software may also be transmitted to location/presence server 1201 via data signals, such as being downloaded electronically via a network, such as the Internet. Location/presence server 1201 is coupled to a display 1220, which may be any type of known display or presentation screen, such as LCD displays, plasma display, cathode ray tubes (CRT), etc. A user input interface 1222 is provided, including one or more user interface mechanisms such as a mouse, keyboard, microphone, touch pad, touch screen, voice-recognition system, etc.

Location/presence server 1201 may be coupled to other computing devices, such as the landline and/or wireless terminals via a network. The server may be part of a larger network configuration as in a global area network (GAN) such as the Internet 1228, which allows ultimate connection to the various landline and/or mobile client/watcher devices.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A method to enhance group communication within a network using presence information, comprising:
maintaining presence information associated with a group of terminals;
maintaining presence information associated with each member of the group of terminals; and
activating a group communication channel from a first member of the group of terminals to available terminals within the group of terminals, wherein availability is determined using presence information associated with the group of terminals and presence information associated with each member of the group of terminals.

2. The method according to claim 1, wherein presence information associated with each member of the group of terminals is maintained within a server coupled to the network.

3. The method according to claim 2, wherein the availability is determined by the server in response to programmable availability rules.

4. The method according to claim 3, wherein the programmable availability rules includes location information associated with each member of the group of terminals.

5. The method according to claim 2, wherein the presence information is communicated to the first member of the group of terminals by the server.

6. The method according to claim 5, wherein the availability is determined by the first member in response to programmable availability rules.

7. The method according to claim 6, wherein the programmable availability rules includes location information associated with each member of the group of terminals.

8. The method according to claim 1, wherein activating the group communication channel includes transmitting an instant message from the first member to the available terminals.

9. The method according to claim 1, wherein activating the group communication channel includes synchronizing a calendar entry of the first member with calendar entries of the available terminals.

10. The method according to claim 1, wherein activating the group communication channel includes synchronizing a task list of the first member with task lists of the available terminals.

11. A presence enhanced group communication system, comprising:
terminals coupled through a network to form a group; and
presence servers coupled to the network and adapted to maintain presence information associated with each of the terminals and adapted to maintain presence information associated with the group, the terminals comprising:
a group presence module adapted to communicate with the presence servers to maintain availability status of the group and each terminal within the group, wherein a group communication channel is established in response to the availability status.

12. The presence enhanced group communication system according to claim 11, further comprising location servers coupled to the network and adapted to maintain location information associated with each terminal of the group.

13. The presence enhanced group communication system according to claim 12, wherein the terminals further comprise a Session Initiation Protocol (SIP) module to facilitate communication with the presence servers and location servers.

14. The presence enhanced group communication system according to claim 13, wherein the group presence module is further adapted to determine the availability status from the presence information and location information associated with each terminal.

15. A mobile terminal wirelessly coupled to a network which includes a group of mobile terminals wirelessly coupled to the network, the mobile terminal comprising:
a memory capable of storing at least one of a group presence module and a protocol module;
a processor coupled to the memory and configured by the group presence module to formulate an availability status associated with each member of the group of mobile terminals; and
a transceiver configured to facilitate content exchange with available members of the group, the available members being selected in accordance with their availability status.

16. The mobile terminal according to claim 15, wherein the protocol module includes a Session Initiation Protocol (SIP) module.

17. The mobile terminal according to claim 15, wherein the content exchange includes an instant message exchange.

18. The mobile terminal according to claim 15, wherein the content exchange includes a calendar synchronization.

19. The mobile terminal according to claim 15, wherein the content exchange includes a task list synchronization.

20. A computer-readable medium having instructions stored thereon which are executable by a mobile terminal for establishing a group communication channel with a group of mobile terminals in a network by performing steps comprising:
accumulating presence information associated with the group and each member of the group of mobile terminals;
determining availability of each member using the accumulated presence information;
displaying the availability of each member; and
creating the group communication channel in response to programmable rules of availability.

21. The computer-readable medium of claim 20, performing steps further comprising displaying a summary availability associated with the group of mobile terminals.

22. The computer-readable medium of claim 20, wherein creating the group communication channel comprises:
determining the communication status requested by each member; and
transmitting information to each member in accordance with the requested communication status.

23. The computer-readable medium of claim 22, wherein transmitting the information includes transmitting an instant message.

24. The computer-readable medium of claim 22, wherein transmitting the information includes synchronizing an electronic calendar of the mobile terminal with an electronic calendar of each member.

25. The computer-readable medium of claim 22, wherein transmitting the information includes synchronizing an electronic task list of the mobile terminal with an electronic task list of each member.

26. A server coupled to a network to facilitate presence based group communication, the server comprising:
means for accumulating presence information relating to a group;
means for accumulating presence information relating to each member of the group;
means for providing the group presence and member presence information in response to requests received for the presence information; and
means for determining availability status of the group and each member of the group in response to programmable rules of availability received from one of the members of the group.

27. The server according to claim 26, further comprising means for accumulating location information relating to each member of the group.

28. A computer-readable medium having instructions stored thereon which are executable by a server to facilitate group communication by performing steps comprising:
accumulating presence information relating to a group;
accumulating presence information relating to each member of the group;
providing the group presence and member presence information in response to requests received for the presence information; and
determining availability status of the group and each member of the group in response to programmable rules of availability received from one of the members of the group.

29. The computer-readable medium according to claim 28, performing steps further comprising accumulating location information relating to each member of the group.

30. A method of managing presence information associated with a group to establish a communication channel with the group, comprising:
activating an information field associated with the group;
monitoring presence information associated with the group;
determining an availability status of the group based on the presence information; and
communicating the information field to the group in response to its availability status.

31. The method according to claim 30, wherein activating the information field comprises activating an instant message portal to generate the information field.

32. The method according to claim 30, wherein activating the information field comprises activating an entry within an electronic calendar.

33. The method according to claim 30, wherein activating the information field comprises activating an entry within an electronic task list.

34. The method according to claim 30, wherein determining an availability status comprises applying programmable availability rules in combination with the presence information.

35. The method according to claim 30, wherein communicating the information field further comprises determining the communication status requested by each member of the group.

36. The method according to claim 35, wherein the communication status comprises a communication preference to be used when communicating the information field.

37. The method according to claim 36, wherein the communication preference comprises one of an email preference, a voice call preference, a Short Message Service (SMS) preference, and an Instant Message (IM) preference.
